(19) United States
(12) Patent Application Publication
(10) Pub. No.: US 2025/0096506 A1
(43) Pub. Date: Mar. 20, 2025

(54) CONNECTOR AND ELECTRONIC DEVICE

(71) Applicant: KYOCERA CORPORATION, Kyoto (JP)

(72) Inventor: Shintaro HORINO, Yokohama-shi, Kanagawa (JP)

(21) Appl. No.: 18/727,616

(22) PCT Filed: Jan. 12, 2023
(86) PCT No.: PCT/JP2023/000664

§ 371 Date: Jul. 9, 2024

(30) Foreign Application Priority Data
Jan. 18, 2022 (JP) 2022-005976

(51) Int. Cl. H01R 13/641; H01R 12/71

(52) U.S. Cl. CPC H01R 13/641; H01R 12/716

(57) ABSTRACT

In the present disclosure, a connector includes an insulator and a first metal fitting. The insulator includes an outer peripheral wall positioned on the outer periphery of the connector. The first metal fitting is attached to the outer peripheral wall. The first metal fitting includes base portions, first extending portions, and a pair of second extending portions. The base portions are disposed along the outer peripheral wall. The first extending portions extend from the base portions inward from the outer peripheral wall. The second extending portions face each other and extend inward from the outer peripheral wall from different positions than the first extending portions. The first extending portions contact a second metal fitting of a connection object and elastically deform toward the outer peripheral wall in a mated state. The second extending portions include engagement portions that engage with the second metal fitting in the mated state.

### CROSS-REFERENCE TO RELATED APPLICATIONS

This application claims priority of Japanese Patent Application No. 2022-005976 filed in Japan on Jan. 18, 2022 and the entire disclosure of this application is hereby incorporated by reference.

### TECHNICAL FIELD

The present disclosure relates to a connector and an electronic device.

### BACKGROUND OF INVENTION

Heretofore, techniques relating to a connector module that includes a connector and a connection object mounted on different circuit boards from each other are widely known. The connector is for electrically connecting the circuit boards to each other. For example, Patent Literature 1 discloses a receptacle connector mounted on a circuit board. This receptacle connector include tab terminals that allow smooth connection and disconnection to and from the counterpart connector and provide stable contact with little degradation even after repeated connection and disconnection.

### CITATION LIST

### Patent Literature

Patent Literature 1: Japanese Patent No. 6884164

### SUMMARY

In an embodiment of the present disclosure, a connector is configured to mate with a connection object. The connector includes an insulator and a first metal fitting. The insulator includes an outer peripheral wall positioned on an outer periphery of the connector. The first metal fitting is attached to the outer peripheral wall.

The first metal fitting includes base portions, first extending portions, and a pair of second extending portions. The base portions are disposed along the outer peripheral wall. The first extending portions extend from the base portions inward from the outer peripheral wall. The second extending portions face each other and extend inward from the outer peripheral wall from different positions than the first extending portions on the base portions. In a mated state in which the connection object and the connector are mated with each other, the first extending portions contact a second metal fitting of the connection object and elastically deform toward the outer peripheral wall.

The second extending portions include engagement portions that engage with the second metal fitting in the mated state.

In an embodiment of the present disclosure, an electronic device includes the connector.

### BRIEF DESCRIPTION OF THE DRAWINGS

FIG. 1 is an external perspective view illustrating, as seen from above, a connector module in a state in which a connector according to an embodiment and a connection object are connected to each other.

FIG. 2 is an external perspective view illustrating, as seen from above, the connector module in a state in which the connector according to an embodiment and the connection object are separated from each other.

FIG. 3 is an external perspective view illustrating only the connector in FIG. 1 as seen from above.

FIG. 4 is an external perspective view in which the connector in FIG. 3 is illustrated in a dissembled state as seen from above.

FIG. 5 is an enlarged view illustrating only a first insulator with a single-dot chain line enclosed part V in FIG. 3 depicted in an enlarged manner.

FIG. 6 is an enlarged view illustrating the single-dot chain line enclosed part V in FIG. 3 in an enlarged manner.

FIG. 7 is an enlarged view illustrating the connector in FIG. 6 as seen from below.

FIG. 8 is an external perspective view illustrating only the connection object in FIG. 1 as seen from above.

FIG. 9 is a sectional view taken along arrow line IX-IX in FIG. 1.

FIG. 10 is a sectional view taken along arrow line X-X in FIG. 1.

FIG. 11 is a sectional view taken along arrow line XI-XI in FIG. 1.

### DESCRIPTION OF EMBODIMENTS

In recent years, there have been demands for electronic devices such as mobile devices including smartphones to be lighter, thinner, and smaller. Accompanying this trend, there have also been demands for connectors mounted inside such electronic devices to be smaller in size and lower in profile. For example, when the profile of a receptacle connector such as that described in Patent Literature 1 is reduced, an elastic contact piece extending inward from an outer peripheral wall of a housing from a metal fitting attached to the outer peripheral wall becomes shorter in length. As the elastic contact piece becomes shorter, the spring elasticity of the elastic contact piece decreases. The elastic contact piece will less easily undergo elastic deformation.

On the other hand, a protrusion may be formed on the surface of such an elastic contact piece in order, for example, to create a clicking sensation during a mating operation or to make point contact with a metal fitting of the counterpart connector. When such a protrusion is formed on the elastic contact piece, the amount of elastic deformation during mating is increased by an amount equivalent to the protrusion. When the connector and the connection object are repeatedly mated and unmated under such conditions, the elastic contact piece, which has become shorter and whose spring elasticity has decreased, is more susceptible to deterioration.

As the elastic contact piece deteriorates, contact pressure applied from the elastic contact piece to the connection object decreases, and the reliability of the contact between the metal fitting and the connection object decreases. This reduces the conductive performance between the connector and the connection object in the mated state and reduces the force with which the connection object is held by the connector. Other problems also arise such as a reduced clicking sensation when the connector and the connection object are mated with each other and a reduced extraction force required when removing the connection object from the connector in the mated state. The workability from mating to removal is reduced.

In an embodiment of the present disclosure, a connector and an electronic device can realize both reliability of contact with a connection object and workability despite being small in size and low in profile.

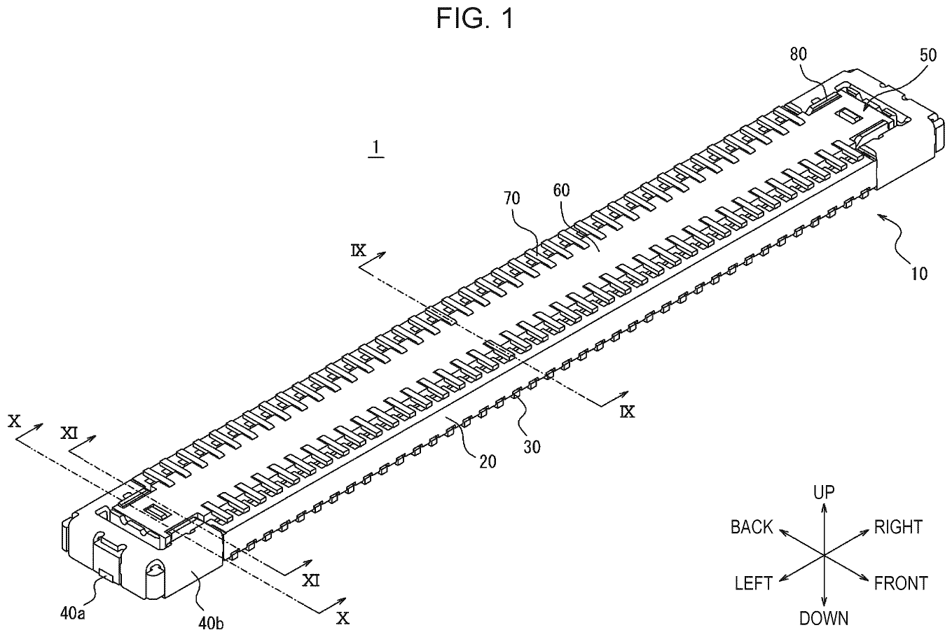

Hereafter an embodiment of the present disclosure will be described in detail while referring to the accompanying drawings. Front-back, left-right, and up-down directions in the following description are based on the directions of the arrows depicted in the figures. The directions of the arrows are consistent with each other between the different drawings in FIGS. 1 to 7 and FIGS. 9 to 11. In some drawings, circuit boards CB1 and CB2 described below are omitted in order to simplify the illustration.

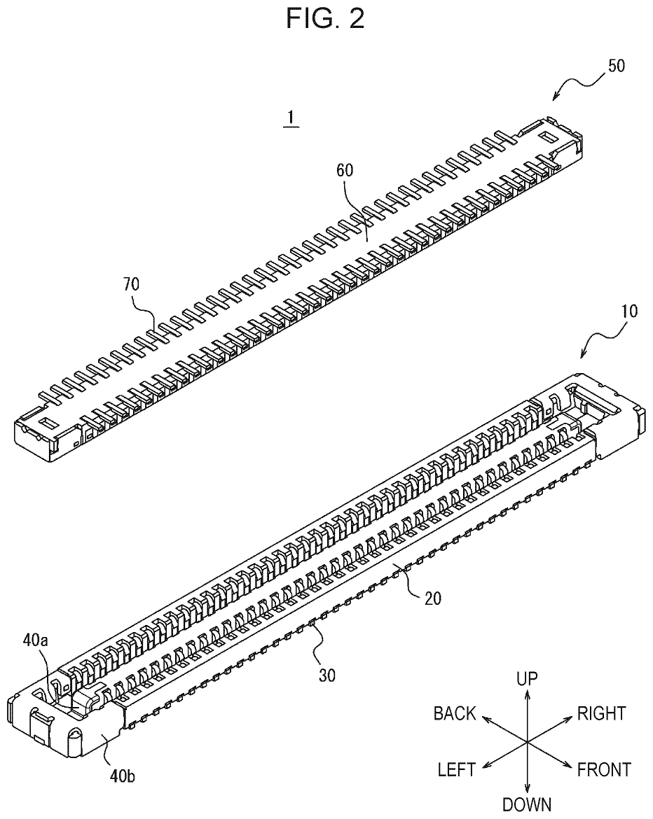

FIG. 1 is an external perspective view illustrating, as seen from above, a connector module 1 in a state in which a connector 10 according to an embodiment and a connection object 50 are connected to each other. FIG. 2 is an external perspective view illustrating, as seen from above, the connector module 1 in a state in which the connector 10 according to an embodiment and the connection object 50 are separated from each other.

For example, as illustrated in FIG. 2, the connector module 1 includes the connector 10 and the connection object 50, which can be connected to each other. The connector 10 includes a first insulator 20 and first contacts 30 attached to the first insulator 20. The connector 10 includes first metal fittings 40b and second metal fittings 40a attached to the first insulator 20.

The connection object 50 can be connected to the connector 10. The connection object 50 includes a second insulator 60 that mates with the first insulator 20 in a connected state where the connector 10 and the connection object 50 are connected to each other. The connection object 50 includes second contacts 70 attached to the second insulator 60. The second contacts 70 contact the first contacts 30 in a mated state in which the first insulator 20 and the second insulator 60 are mated with each other. The connection object 50 includes second metal fittings 80 attached to the second insulator 60. The second metal fittings 80 contact the first metal fittings 40b in the mated state. At this time, the first metal fittings 40b elastically deform.

Hereafter, for example, the connector 10 according to an embodiment is described as a receptacle connector. The connection object 50 is described as a plug connector. The connector 10, in which the first contacts 30 elastically deform in the mated state in which the first insulator 20 and second insulator 60 are mated with each other, is described as a receptacle connector. The connection object 50, in which the second contacts 70 do not elastically deform, is described as a plug connector. The connector 10 and the connection object 50 are not limited to these types of connectors. For example, the connector 10 may serve as a plug connector. The connection object 50 may serve as a receptacle connector.

The connection object 50 is not limited to the above configuration and may be any object other than a plug connector and a receptacle connector. For example, the connection object 50 may be a flexible printed circuit board (FPC), a flexible flat cable, a rigid substrate, or the card edge of any circuit board.

Hereafter, the connector 10 and the connection object 50 are described as being respectively mounted on the circuit boards CB1 and CB2. The connector 10 and the connection object 50 electrically connect the circuit board CB1 and the circuit board CB2 to each other in a connected state in which the connector 10 and the connection object 50 are connected to each other. The circuit boards CB1 and CB2 may be rigid boards or any other type of circuit board. For example, at least one of the circuit board CB1 or CB2 may be an FPC.

Hereafter, the connector 10 and the connection object 50 are described as being connected to each other in a direction perpendicular to the circuit boards CB1 and CB2. The connector 10 and the connection object 50 are connected to each other along the up-down direction as an example. The connection method is not limited to this example. The connector 10 and the connection object 50 may be connected to each other in a direction parallel to the circuit boards CB1 and CB2. The connector 10 and the connection object 50 may be connected to each other such that one is perpendicular to the mounting circuit board and the other is parallel to the mounting circuit board.

In this specification, a “longitudinal direction” corresponds to a left-right direction as an example. A “lateral direction” corresponds to a front-back direction as an example. A “projection direction” corresponds to the front-back direction as an example. A “mating direction” corresponds to an up-down direction as an example. A “mating side” corresponds to the upper side as an example. An “opposite side from the mating side” corresponds to the lower side as an example. A “circuit board CB1 side” corresponds to the lower side as an example.

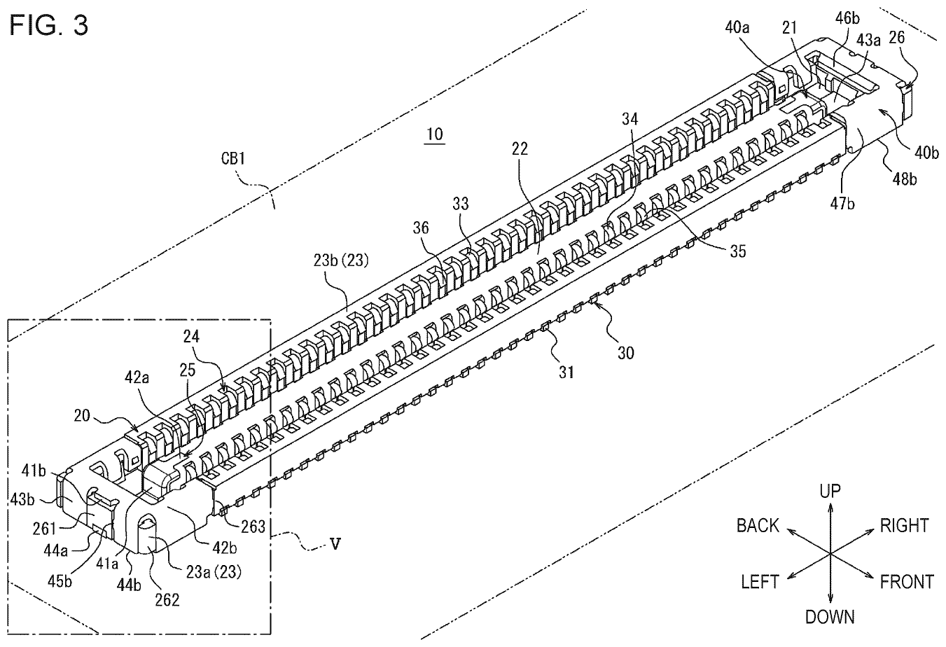

FIG. 3 is an external perspective view illustrating only the connector 10 in FIG. 1 as seen from above. As an example, the connector 10 is obtained by press-fitting the first contacts 30 and the first metal fittings 40b into the first insulator 20, and integrally molding the second metal fittings 40a and the first insulator 20 with each other through insert molding.

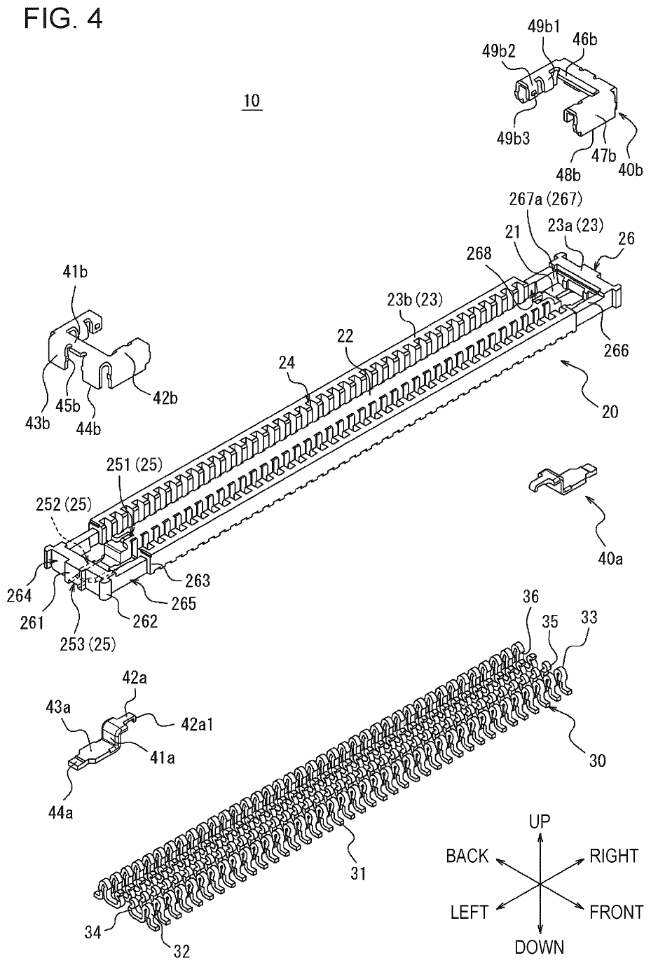

FIG. 4 is an external perspective view in which the connector 10 in FIG. 3 is illustrated in a dissembled state as seen from above. In reality, the second metal fittings 40a and the first insulator 20 are integrally molded with each other by insert molding, but in FIG. 4, the first insulator 20 and the second metal fittings 40a are illustrated as separate bodies virtually separated from each other for ease of understanding.

The first insulator 20 of the connector 10 is formed of an insulating and heat-resistant synthetic resin material. The first insulator 20 extends in a plate-like shape in the left-right direction. The first insulator 20 includes a bottom plate portion 21 constituting a bottom part of the first insulator 20. The first insulator 20 includes a mating protrusion 22 projecting upward from the center of the bottom plate portion 21 in the front-back and left-right directions. The first insulator 20 includes an outer peripheral wall 23 surrounding the mating protrusion 22. The outer peripheral wall 23 forms the outer periphery of the connector 10. The outer peripheral wall 23 surrounds the mating protrusion 22 from four directions, i.e., from the front, the back, the left, and the right. The outer peripheral wall 23 includes short walls 23a and long walls 23b. The short walls 23a extend in the front-back direction. The long walls 23b extend in the left-right direction.

The first insulator 20 includes first contact mounting grooves 24 formed across the inner surfaces, in the front-back direction, of the long walls 23b, the bottom plate portion 21, and the inner surfaces, in the front-back direction, of the mating protrusion 22. The first contacts 30 are mounted in the first contact mounting grooves 24. The first contact mounting grooves 24 are formed in multiple locations corresponding to the number of first contacts 30. The multiple first contact mounting grooves 24 are arranged along the arrangement direction of the first contacts 30.

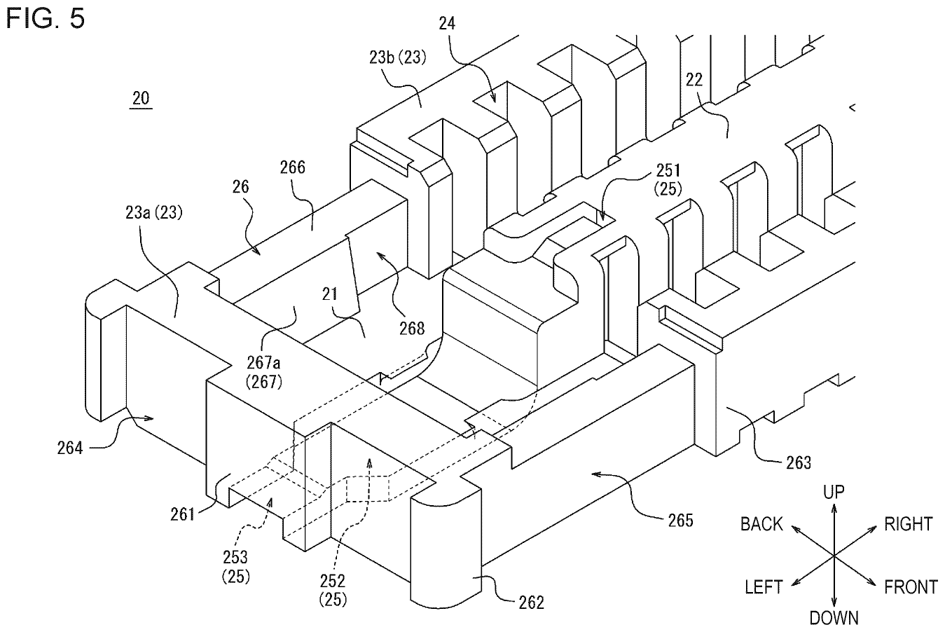

FIG. 5 is an enlarged view illustrating only the first insulator 20 with a single-dot chain line enclosed part V in FIG. 3 depicted in an enlarged manner. While referring to FIG. 5, the configuration of a second metal fitting holding portion 25 and a first metal fitting mounting portion 26 of the first insulator 20 will be described in detail.

The first insulator 20 includes the second metal fitting holding portion 25. The second metal fitting holding portion 25 extends from an end portion, in left-right direction, of the mating protrusion 22 across the bottom plate portion 21 to the short wall 23a. The second metal fitting holding portion 25 includes a first part 251 that is recessed in an end portion, in the left-right direction, of the mating protrusion 22. The second metal fitting holding portion 25 includes a second part 252 formed so as to penetrate through the bottom plate portion 21. The second metal fitting holding portion 25 includes a third part 253 recessed in the bottom surface of the short wall 23a. The second metal fitting 40a is attached to the second metal fitting holding portion 25. The second metal fitting holding portion 25 extends along the left-right direction so as to connect the mating protrusion 22 to the short wall 23a.

The first insulator 20 includes the first metal fitting mounting portion 26 formed so as to extend between the short wall 23a and the end portions, in the left-right direction, of the long walls 23b. The first metal fitting 40b is attached to the first metal fitting mounting portion 26.

The first metal fitting mounting portion 26 includes a first wall portion 261 formed in the center, in the front-back direction, of the short wall 23a and projecting outward in the left-right direction. The third part 253 of the second metal fitting holding portion 25 is recessed in the bottom surface of the first wall portion 261. The first metal fitting mounting portion 26 includes second wall portions 262 formed so as to extend from the short wall 23a to the long walls 23b at the corners of the first insulator 20. The first metal fitting mounting portion 26 includes third wall portions 263 formed in the long walls 23b so as to be separated from the second wall portions 262 in the left-right direction. The first wall portion 261, the second wall portions 262, and the third wall portions 263 form the rectangular outermost shape of the first insulator 20 in the left-right and front-back directions.

The first metal fitting mounting portion 26 includes first attachment grooves 264 formed between the first wall portion 261 and the second wall portions 262. The first metal fitting mounting portion 26 includes second attachment grooves 265 formed between the second wall portions 262 and the third wall portions 263.

The first metal fitting mounting portion 26 includes fourth wall portions 266 that extend in straight lines in the left-right direction between the third wall portions 263 and the short wall 23a and have a height in the up-down direction that is one step lower than the other parts of the long walls 23b. The first metal fitting mounting portion 26 includes contacted portions 267 formed continuously from the fourth wall portions 266 on the inner side of the outer peripheral wall 23.

With respect to the mating side where mating between the connection object 50 and the connector 10 takes place, the contacted portions 267 are formed on the opposite side from the mating side and on the inner side of the outer peripheral wall 23. For example, the contacted portions 267 have inclined surfaces 267a that are inclined inward from the outer peripheral wall 23 as one moves toward the opposite side from the mating side between the connection object 50 and the connector 10 on the fourth wall portions 266, i.e., the long walls 23b. The contacted portions 267 including the inclined surfaces 267a extend in the left-right direction along the fourth wall portions 266 from the short wall 23a up to positions between the short wall 23a and the third wall portions 263. The first metal fitting mounting portion 26 includes recesses 268 formed between the contacted portions 267 and the third wall portions 263.

The first contacts 30 are, for example, each composed of a thin sheet of phosphor bronze, beryllium copper, or a copper alloy including titanium copper or a Corson-type copper alloy having spring elasticity molded into the shape illustrated in FIG. 4 using a progressive die (stamping). The surface of each first contact 30 is plated with nickel to form a base and is then plated with gold or tin etc.

The first contacts 30 each include a mounting portion 31 extending in an L-shape toward the outside in the front-back direction. The first contacts 30 each include a locking portion 32 that extends upward in a continuous manner from the upper end portion of a mounting portion 31. The locking portion 32 is formed so as to be wider than the mounting portion 31 in the left-right direction. The first contacts 30 each include a curved portion 33 that projects upward in a U-shape from the locking portion 32.

The first contacts 30 each include an elastic contact piece 34 connected to the curved portion 33 and formed in an S-shape. The first contacts 30 each include an elastic contact portion 35 formed to face outward in the front-back direction at a curved part of a tip of the elastic contact piece 34. The first contacts 30 each include a contact portion 36 protruding at a position facing the elastic contact portion 35 in the front-back direction on the curved portion 33.

Each second metal fitting 40a is composed of a thin sheet of any metal material molded into the shape illustrated in FIG. 4 using a progressive die (stamping). The processing method used for the second metal fitting 40a includes a process based on punching and bending in the thickness direction. Not limited to this configuration, the second metal fitting 40a may be fabricated using a process including drawing so that the faces of the first base portion 41a in the front-back direction and the left-right direction and the up direction, as described below, are continuous without gaps.

The second metal fitting 40a is formed so as to be shape like a crank on the whole. More specifically, a claw portion 42a, a first base portion 41a, and a second base portion 43a, which are described below, are formed in an integrated manner so as to form a crank-like shape on the whole. Similarly, the first base portion 41a and the second base portion 43a are formed in an integrated manner so as to form a crank-like shape on the whole.

The second metal fitting 40a includes the first base portion 41a. The first base portion 41a extends upward in a straight line and bends toward one side in the left-right direction at the upper end thereof. The first base portion 41a is formed in an L-shape. The first base portion 41a connects the second base portion 43a and the claw portion 42a, which are described later, to each other.

The second metal fitting 40a includes the claw portion 42a. The claw portion 42a extends further toward the one side in the left-right direction from the part of the first base portion 41a that extends toward the one side in the left-right direction. The claw portion 42a is formed in an L-shape. For example, a tip 42a1 of the claw portion 42a is bent downward at the end portion of the claw portion 42a on the one side. The claw portion 42a is narrower than the rest of the second metal fitting 40a in the front-back direction. For example, the front-back direction width of the claw portion 42a is smaller than the front-back direction width of the first base portion 41a, which is continuous with the claw portion 42a. For example, the front-back direction width of the claw portion 42a is smaller than the widths, in the front-back direction, of the second base portion 43a and a mounting portion 44a, which are described below.

The second metal fitting 40a includes the second base portion 43a. The second base portion 43a extends in a straight line toward the other side in the left-right direction from the lower end portion of the first base portion 41a. The front-back direction width of the second base portion 43a is identical to the front-back direction width of the first base portion 41a, which is continuous with the second base portion 43a.

The second metal fitting 40a includes the mounting portion 44a. The mounting portion 44a extends in a straight line from the second base portion 43a toward the other side in the left-right direction so as to become narrower in the front-back direction. The mounting portion 44a is bent diagonally downward from the second base portion 43a and then extends in a straight line toward the other side in the left-right direction. The mounting portion 44a is located one step below the second base portion 43a.

Each first metal fitting 40b is composed of a thin sheet of any metal material molded into the shape illustrated in FIG. 4 using a progressive die (stamping). The processing method used for the first metal fitting 40b includes a process of performing punching and then bending the metal sheet in the thickness direction. Not limited to this, the first metal fitting 40b may be fabricated using a process that includes drawing.

The first metal fitting 40b includes a first base portion 41b extending in the front-back direction. The first metal fitting 40b includes second base portions 42b extending toward one side in the left-right direction from both end portions, in the front-back direction, of the first base portion 41b. The first metal fitting 40b includes projecting pieces 43b extending downward in a straight line from both a front portion and a rear portion of the first base portion 41b. A recess is formed by the opposing edges of the pair of projecting pieces 43b, which are separated from each other in the front-back direction, and the lower edge of the first base portion 41b. The first metal fitting 40b includes first mounting portions 44b located at the lower ends of the projecting pieces 43b. The first metal fitting 40b includes first locking portions 45b formed so as to be wider in the front-back direction than the other parts of the projecting pieces 43b.

The first metal fitting 40b includes a bent portion 46b that is folded toward the inside of the first metal fitting 40b from substantially the entirety of one edge portion in the left-right direction of the first base portion 41b positioned between the pair of second base portions 42b.

The first metal fitting 40b includes second locking portions 47b extending downward across substantially the entirety of the left-right direction from the outer edges, in the front-back direction, of the second base portions 42b. The second locking portions 47b are formed so as to be wider in the left-right direction than the second base portions 42b. The first metal fitting 40b includes second mounting portions 48b extending across substantially the entirety of the left-right direction at the lower edges of the second locking portions 47b.

The first metal fitting 40b includes first extending portions 49b1 extending toward the inside of the first metal fitting 40b from the edges of the second base portions 42b on the opposite side from the second locking portions 47b. The first extending portions 49b1 extend from the center, in the left-right direction, of the inner edges, in the front-back direction, of the second base portions 42b and are bent diagonally downward. The first extending portions 49b1 extend up to positions corresponding to center portions of the second locking portions 47b in the up-down direction. The first extending portions 49b1 are inclined inward in the front-back direction from above to below. The first extending portions 49b1 are elastically deformable along the front-back direction toward the second locking portions 47b when contact pressure is applied from a free state, in which no contact pressure is applied, due to contact with the connection object 50. The first extending portions 49b1 have spring elasticity.

The first metal fitting 40b includes second extending portions 49b2 extending toward the inside of the first metal fitting 40b from the edges of the second base portions 42b on the opposite side from the second locking portions 47b. The second extending portions 49b2 extend from one end, in the left-right direction, of the inner edges, in the front-back direction, of the second base portions 42b and are bent downward. The second extending portions 49b2 are adjacent to the first extending portions 49b1 on one side in the left-right direction. The second extending portions 49b2 extend up to positions corresponding to center portions of the second locking portions 47b in the up-down direction. The second extending portions 49b2 extend downward in straight lines. The second extending portions 49b2 are slightly elastically deformable along the front-back direction toward the second locking portions 47b when contact pressure is applied from a free state in which no contact pressure is applied due to contact with the connection object 50. The second extending portions 49b2 have spring elasticity. However, the second extending portions 49b2 are less elastically deformable than the first extending portions 49b1.

The first metal fitting 40b includes engagement portions 49b3 formed on surfaces, in the front-back direction, of the second extending portions 49b2 facing toward the opposite side from the second locking portions 47b. Each engagement portion 49b3 includes, on the surface of the second extending portion 49b2, a protrusion that projects toward the opposite side from the second locking portion 47b.

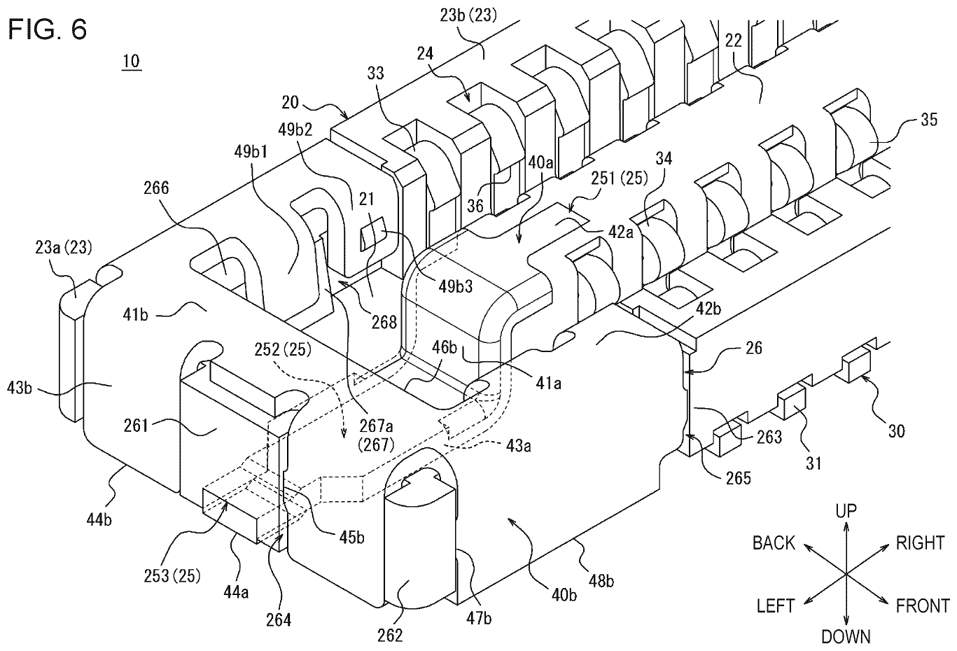

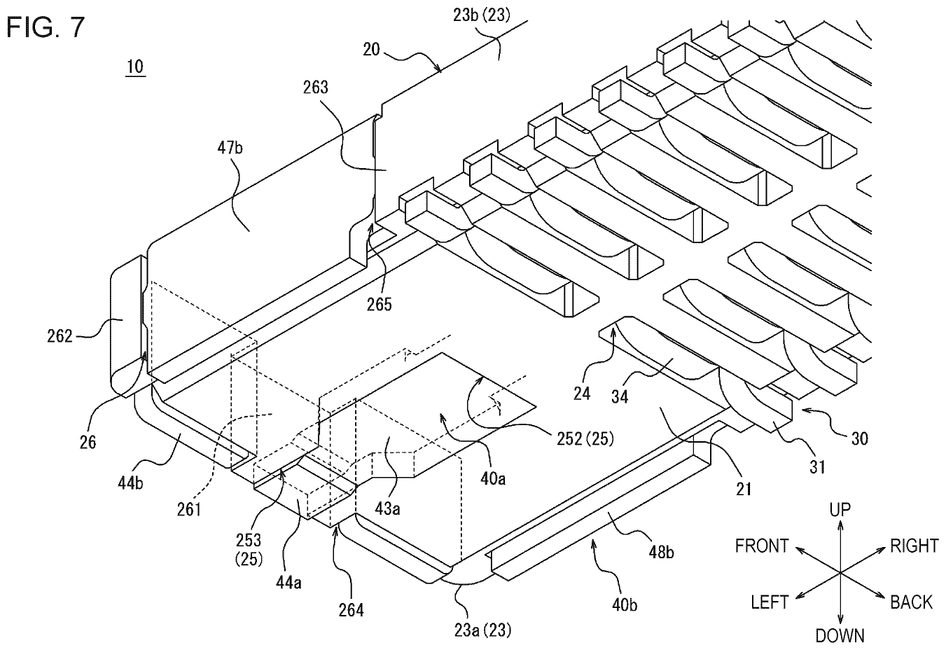

FIG. 6 is an enlarged view illustrating the single-dot chain line enclosed part V in FIG. 3 in an enlarged manner. FIG. 7 is an enlarged view illustrating the connector 10 in FIG. 6 as seen from below.

The first contacts 30 are press-fitted into the first insulator 20 from below. At this time, the locking portions 32 lock against the inner wall surfaces, in the left-right direction, of the first contact mounting grooves 24. In this way, the first contacts 30 are held in the first contact mounting grooves 24.

When the first contacts 30 are held in the first contact mounting grooves 24 of the first insulator 20, the elastic contact portions 35 and the contact portions 36 are exposed from the first contact mounting grooves 24 between the mating protrusion 22 and the long walls 23b. At this time, the elastic contact pieces 34 can elastically deform in the front-back direction inside the first contact mounting grooves 24. The tips of the mounting portions 31 in the front-back direction are at substantially the same front-back positions as the long walls 23b.

As illustrated in FIGS. 6 and 7, the first metal fitting 40b and the second metal fitting 40a are different members. The first metal fitting 40b and the second metal fitting 40a are separated from each other. The first metal fitting 40b and the second metal fitting 40a are separated from each other and face each other in the left-right direction. The first metal fitting 40b and the second metal fitting 40a have different strengths from each other. The strength of one of the first metal fitting 40b and the second metal fitting 40a is higher than the strength of the other. For example, the strength of the second metal fitting 40a may be higher than the strength of the first metal fitting 40b. For example, the strength of the material of the second metal fitting 40a may be higher than the strength of the material of the first metal fitting 40b. In the present specification, “strength” includes, for example, tensile strength.

The material of the second metal fitting 40a may be different from the material of the first metal fitting 40b. For example, the material of the second metal fitting 40a may be stainless steel and the material of the first metal fitting 40b may be phosphor bronze. Not limited to this, the material of the first metal fitting 40b and the material of the second metal fitting 40a may be selected from a group of candidate materials in any combination such that the strength of the second metal fitting 40a is higher than the strength of the first metal fitting 40b. In the present specification, the “group of candidate materials” includes, for example, stainless steel, phosphor bronze, iron, Corson copper, titanium copper, beryllium copper, and aluminum.

The material of the second metal fitting 40a may be the same as the material of the first metal fitting 40b so long as the strength of the second metal fitting 40a is higher than that of the first metal fitting 40b. For example, even if the same material such as phosphor bronze is used, the strength of the second metal fitting 40a may be higher than the strength of the first metal fitting 40b due to the alloy number, type symbol, quality classification, and so forth being different. For example, the strength of the second metal fitting 40a may be higher than that of the first metal fitting 40b, even though the same material such as phosphor bronze is used, due to the thickness of the second metal fitting 40a being greater than that of the first metal fitting 40b, as described below.

For example, the strength of the first contacts 30 may be substantially the same as the strength of the first metal fitting 40b. The strength of the second metal fitting 40a may be higher than the strength of the first contacts 30 and the first metal fitting 40b. The material of the first metal fitting 40b, the material of the second metal fitting 40a, and the material of the first contacts 30 may be selected from a group of candidate materials in any combination that establishes the above strength relationship between the first metal fitting 40b, the second metal fitting 40a, and the first contacts 30.

A pair of second metal fittings 40a are attached to both ends of the mating protrusion 22 in the longitudinal direction of the connector 10. Each second metal fitting 40a extends along the longitudinal direction of the connector 10 from the mating protrusion 22 to the short wall 23a where the first metal fitting 40b is attached.

For example, the second metal fitting 40a is integrally molded with the second metal fitting holding portion 25 of the first insulator 20 by insert molding. At this time, the first base portion 41a is integrally molded with the mating protrusion 22 so as to extend from the top surface to the side surface of the end portion of the mating protrusion 22 in the left-right direction. For example, the first base portion 41a is integrally molded with the first part 251 of the second metal fitting holding portion 25. The first base portion 41a covers the entire end portion of the mating protrusion 22 in the left-right direction from the outside.

The claw portion 42a is integrally molded with the mating protrusion 22 on the top surface of the mating protrusion 22 so that the tip 42a1 of the claw portion 42a is buried inside the mating protrusion 22. The top surface of the claw portion 42a is exposed from the first insulator 20. For example, the top surface of the claw portion 42a is flush with the top surface of the mating protrusion 22. Not limited to this configuration, the top surface of the claw portion 42a may be positioned below the top surface of the mating protrusion 22.

The second metal fitting 40a overlaps, along the arrangement direction of the first contacts 30, with one first contact 30 positioned at the end in the arrangement direction, among the multiple first contacts 30 disposed along the arrangement direction, parallel to the longitudinal direction of the connector 10. For example, as illustrated in FIG. 6, the claw portion 42a of the second metal fitting 40a overlaps, along the arrangement direction, with one first contact 30 positioned at the end in the arrangement direction. For example, the left-right position of a portion of the part of the claw portion 42a extending in the left-right direction is the same as the left-right position of the one first contact 30.

The tip 42a1 of the claw portion 42a of the second metal fitting 40a is positioned between the one first contact 30 and another first contact 30 adjacent to the one first contact 30 in the arrangement direction. For example, a portion of the part of the claw portion 42a extending in the left-right direction is also positioned between the one first contact 30 and the other first contact 30 in the arrangement direction together with the tip 42a1, which is bent to extend in the up-down direction.

The second base portion 43a is integrally molded with the bottom plate portion 21 and the short wall 23a. For example, the second base portion 43a is integrally molded with the second part 252 of the second metal fitting holding portion 25. The mounting portion 44a is integrally molded with the third part 253 of the second metal fitting holding portion 25. In this state, the tip of the mounting portion 44a in the left-right direction is exposed to the outside in the left-right direction from the first wall portion 261 of the short wall 23a.

When the second metal fitting 40a and the first insulator 20 are integrally molded with each other by insert molding, the second base portion 43a extends along the longitudinal direction of the connector 10. The second base portion 43a extends from the mating protrusion 22 up to the short wall 23a to which the first metal fitting 40b is attached. The bottom surface of the mounting portion 44a is positioned one step lower than the bottom surface of the bottom plate portion 21 of the first insulator 20. The mounting portion 44a is positioned directly below the short wall 23a in the left-right direction.

For example, the first metal fitting 40b is press-fitted into the first insulator 20 from above. The first metal fitting 40b is attached to the outer peripheral wall 23 so that the recess, which is formed by the opposing edges of the pair of projecting pieces 43b, which are separated from each other in the front-back direction, and the lower edge of the first base portion 41b, pinches the first wall portion 261.

At this time, the first locking portions 45b are locked against the first wall portion 261 of the first metal fitting mounting portion 26 on the outside of the short wall 23a in the left-right direction. The pair of projecting pieces 43b, which are separated from each other in the front-back direction, are attached to the first attachment grooves 264. Similarly, the second locking portions 47b are locked against the second wall portions 262 and the third wall portions 263 of the first metal fitting mounting portion 26 on the outside of the long walls 23b in the front-back direction. The second locking portions 47b are attached to the second attachment grooves 265. In this way, the first metal fitting 40b is held against the first metal fitting mounting portion 26.

The first base portion 41b and the second base portions 42b of the first metal fitting 40b are disposed along the outer peripheral wall 23. More specifically, the first base portion 41b is disposed along the short wall 23a. The second base portions 42b are disposed along the long walls 23b. The first extending portions 49b1 extend toward the inside of the outer peripheral wall 23 from the second base portions 42b. The second extending portions 49b2 extend toward the inside of the outer peripheral wall 23 from different positions from the first extending portions 49b1 on the second base portions 42b.

The first extending portions 49b1 and the second extending portions 49b2 are positioned on the long walls 23b. The first extending portions 49b1 and the second extending portions 49b2 are adjacent to each other in the left-right direction along the long walls 23b. The first extending portions 49b1 are positioned nearer to the short wall 23a than the second extending portions 49b2 are on the long walls 23b. The first extending portions 49b1 are positioned nearer to the outside in the left-right direction than the second extending portions 49b2 are on the long walls 23b.

The second extending portions 49b2 face the mating protrusion 22 of the first insulator 20 in the front-back direction. The second extending portions 49b2 at least partially overlap the end portion of the mating protrusion 22 in the left-right direction when viewed in the front-back direction. In FIG. 6, as an example, the entirety of each second extending portion 49b2 overlaps the end portion of the mating protrusion 22 in the left-right direction when viewed in the front-back direction. The pair of second extending portions 49b2, which are positioned on the pair of long walls 23b and separated from each other by a prescribed spacing in the front-back direction, face each other in the front-back direction with the end portion, in the left-right direction, of the mating protrusion 22 interposed therebetween. The pair of second extending portions 49b2 are formed at the same left-right position and the same up-down position as each other in the first metal fitting 40b.

The protrusions included in the engagement portions 49b3 of the second extending portions 49b2 project away from the outer peripheral wall 23 on the surfaces of the second extending portions 49b2. The protrusions of the pair of engagement portions 49b3, which face each other on the pair of second extending portions 49b2, face each other in the front-back direction with the end portion, in the left-right direction, of the mating protrusion 22 interposed therebetween. The pair of engagement portions 49b3 are formed at the same left-right position and the same up-down position as each other in the first metal fitting 40b.

The first extending portions 49b1 and the second extending portions 49b2 are formed to have substantially the same width as each other along the long walls 23b. The left-right width of the first extending portions 49b1 and the left-right width of the second extending portions 49b2 are substantially identical. The thickness of the first extending portions 49b1 and the thickness of the second extending portions 49b2 are substantially identical.

When the first metal fitting 40b is held in the first metal fitting mounting portion 26 of the first insulator 20, the first metal fitting 40b covers the entirety of the short wall 23a and the ends, in the left-right direction, of the long walls 23b. At this time, the first metal fitting 40b surrounds the second base portion 43a of the second metal fitting 40a from both the front side and the back side and from the outside in the left-right direction. More specifically, the second base portions 42b of the first metal fitting 40b are disposed both at the front side and the back side of the second base portion 43a of the second metal fitting 40a. The first base portion 41b, the projecting pieces 43b, and the bent portion 46b of the first metal fitting 40b are disposed so as to overlap in the left-right direction the outer end portion, in the left-right direction, of the second base portion 43a and the mounting portion 44a of the second metal fitting 40a.

The first mounting portions 44b are disposed along the outer surface, in the left-right direction, of the short wall 23a. The first mounting portions 44b extend to below the lower end portion of the short wall 23a. The first mounting portions 44b are disposed on both sides of the mounting portion 44a of the second metal fitting 40a in the lateral direction of the connector 10. The pair of first mounting portions 44b are positioned so as to pinch the mounting portion 44a of the second metal fitting 40a therebetween from both sides in the front-back direction. For example, the pair of first mounting portions 44b are respectively disposed at symmetrical positions with respect to the mounting portion 44a of the second metal fitting 40a in the front-back direction.

The second mounting portions 48b are disposed on the outer surfaces of the long walls 23b in the front-back direction. The second mounting portions 48b extend to below the lower end portions of the long walls 23b. The second mounting portions 48b are disposed on both sides of the second metal fitting 40a in the lateral direction of the connector 10. The pair of second mounting portions 48b are disposed so as to pinch the second base portion 43a of the second metal fitting 40a therebetween from both sides in the front-back direction. For example, the pair of second mounting portions 48b are respectively disposed at symmetrical positions with respect to the second base portion 43a in the front-back direction.

In the connector 10 having the above-described structure, the mounting portions 31 of the first contacts 30 are soldered to circuit patterns formed on a mounting surface of the circuit board CB1. The mounting portion 44a of the second metal fitting 40a and the first mounting portions 44b and the second mounting portions 48b of the first metal fitting 40b are soldered to patterns formed on the mounting surface. As described above, each mounting portion is mounted on the circuit board CB1, and thus, the connector 10 is mounted on the circuit board CB1. Electronic components other than the connector 10, such as a CPU (Central Processing Unit), a controller, and a memory, are mounted on the mounting surface of the circuit board CB1.

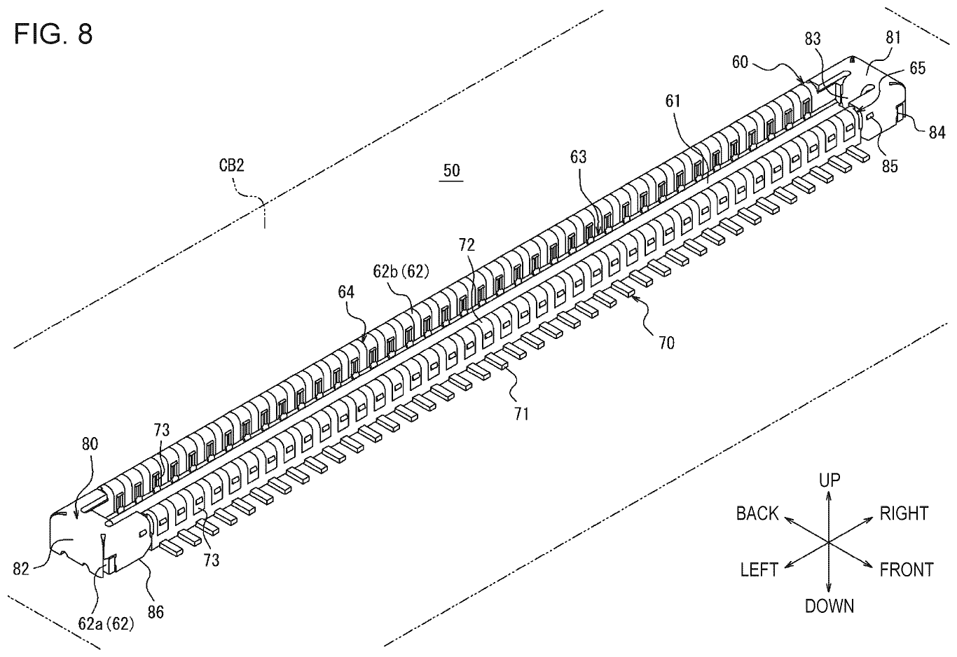

The configuration of the connection object 50 will be described while mainly referring to FIG. 8.

FIG. 8 is an external perspective view illustrating only the connection object 50 in FIG. 1 as seen from above. As an example, the connection object 50 is obtained by integrally molding the second contacts 70 and the second insulator 60 with each other by insert molding, and press-fitting the second metal fittings 80 into the second insulator 60 from above.

The second insulator 60 is a plate-shaped member extending in the left-right direction obtained by injection molding an insulating and heat-resistant synthetic resin material. The second insulator 60 includes a bottom plate portion 61 constituting a bottom part of the second insulator 60. The second insulator 60 includes an annular outer peripheral wall 62 that projects upward along outer periphery of the bottom plate portion 61 at the front, back, left, and right. The outer peripheral wall 62 includes short walls 62a and long walls 62b. The short walls 62a extend in the front-back direction. The long walls 62b extend in the left-right direction. The second insulator 60 includes a mating recess 63 surrounded from four directions, i.e., front, back, left, and right, by the outer peripheral wall 62.

The second insulator 60 includes second contact holding portions 64 formed across the long walls 62b and the bottom plate portion 61. The second contacts 70 are mounted in the second contact holding portions 64. The second insulator 60 includes metal fitting holding portions 65 formed to extend from the ends of the long walls 62b in the left-right direction to the short walls 62a. The second metal fittings 80 are attached to the metal fitting holding portions 65.

The second contacts 70 are, for example, each composed a thin sheet of phosphor bronze, beryllium copper, or a copper alloy including titanium copper or a Corson-type copper alloy molded into the shape illustrated in the figures using a progressive die (stamping). The surface of each second contact 70 is plated with nickel to form a base and is then plated with gold or tin etc.

The second contacts 70 each include a mounting portion 71 extending in an L-shape toward the outside in the front-back direction. The second contacts 70 each include a curved portion 72 that extends in a U-shape facing upward from the mounting portion 71. The second contacts 70 each include a pair of contact portions 73 configured to include side surfaces, in the front-back direction, on both the front side and the back side of the curved portion 72.

The second contacts 70 are integrally molded with the second contact holding portions 64 of the second insulator 60 by insert molding. At this time, each pair of contact portions 73 is disposed along the front side and rear side of the corresponding long wall 62b, respectively. The mounting portions 71 penetrate through the bottom plate portion 61 and extend toward the outside in the front-back direction. The tips of the mounting portions 71 in the front-back direction are positioned nearer to the outside in the front-back direction than the long walls 62b are.

Each second metal fitting 80 is composed of a thin sheet of any metal material molded into the shape illustrated in the figures using a progressive die (stamping). The processing method used for the second metal fitting 80 includes a process of performing punching and then bending the metal sheet in the thickness direction.

The second metal fitting 80 includes a base portion 81 including the top surface along the front-back direction and the left-right direction of the second metal fitting 80. The second metal fitting 80 includes a first mounting portion 82 that extends downward after bending from the outer edge, in the left-right direction, of the part of the base portion 81 extending along the front-back direction. The second metal fitting 80 includes a first locking portion 83 that extends downward after bending from the inner edge, in the left-right direction, of the part of the base portion 81 extending along the front-back direction.

The second metal fitting 80 includes second locking portions 84 that extend downward after bending from the outer edges, in the front-back direction, of the part of the base portion 81 extending along the left-right direction. The second metal fitting 80 includes protrusions 85 protruding on the outer surfaces, in the front-back direction, of the second locking portions 84. The second metal fitting 80 includes second mounting portions 86 positioned at the lower ends of the second locking portions 84. The second metal fitting 80 is attached to the second insulator 60 by the first locking portion 83 and the second locking portions 84 locking against the metal fitting holding portion 65 of the second insulator 60.

In the connection object 50 having the above-described structure, the mounting portions 71 of the second contacts 70 are soldered to circuit patterns formed on a mounting surface of the circuit board CB2. The first mounting portions 82 and the second mounting portions 86 of the second metal fittings 80 are soldered to patterns formed on the mounting surface. In this way, the connection object 50 is mounted on the circuit board CB2. Electronic components other than the connection object 50, such as a communication module, are mounted on the mounting surface of the circuit board CB2.

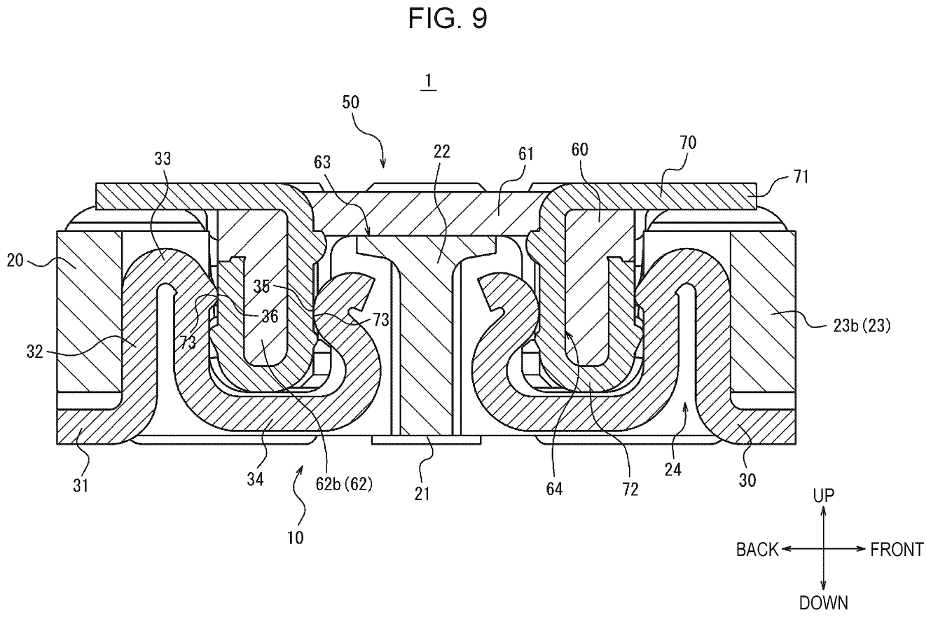

The configuration of the connector module 1 in the mated state, in which the connector 10 and the connection object 50 are connected to each other and the first insulator 20 and the second insulator 60 are mated with each other, will be mainly described while referring to FIGS. 9 to 11. FIG. 9 is a sectional view taken along arrow line IX-IX in FIG. 1.

For example, with the orientation of the connection object 50 illustrated in FIG. 8 in the up-down direction reversed, the connector 10 and the connection object 50 are made to face each other in the up-down direction with their front-back positions and left-right positions substantially aligned with each other. The connection object 50 is moved downward. In this way, the connector 10 and the connection object 50 are connected to each other, and the connected state of the connector module 1 is obtained. At this time, the mating protrusion 22 of the first insulator 20 and the mating recess 63 of the second insulator 60 mate with each other. The connector 10 mates with the connection object 50.

In the mated state, the elastic contact portions 35 of the first contacts 30 and the contact portions 73 of the second contacts 70 contact each other, and the elastic contact pieces 34, which have elasticity, are elastically deformed inward in the front-back direction. In the mated state, the contact portions 36 of the first contacts 30 and the contact portions 73 of the second contacts 70 contact each other. Each first contact 30 and corresponding second contact 70 contact each other at two places on both the front side and the back side due to the elastic contact portion 35 and the contact portion 73 contacting each other and the contact portion 36 and the contact portion 73 contacting each other.

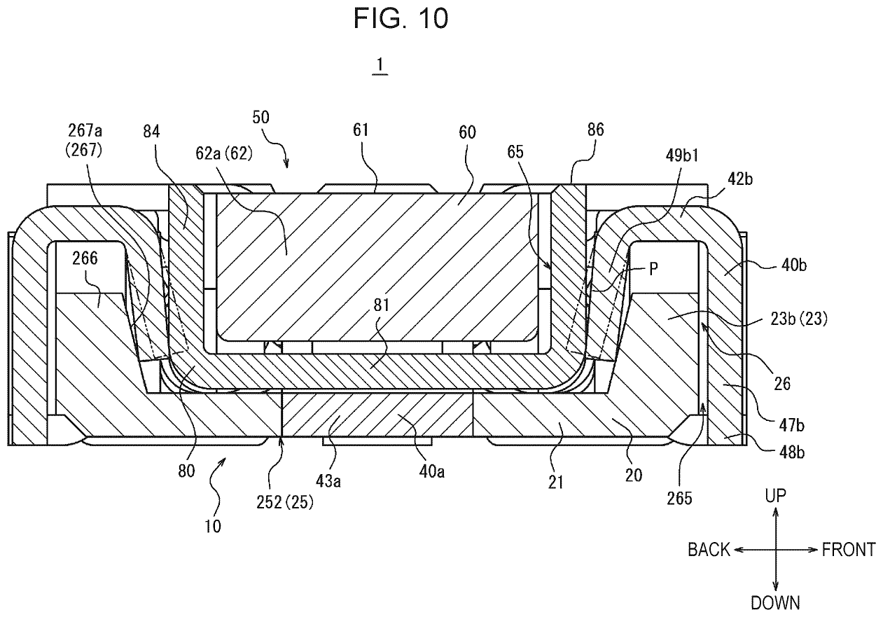

FIG. 10 is a sectional view taken along arrow line X-X in FIG. 1.

In the mated state, the first extending portions 49b1 of the first metal fitting 40b and the second locking portions 84 of the second metal fitting 80 contact each other. At this time, the first extending portions 49b1, which have spring elasticity, are elastically deformed toward the outside in the front-back direction. In the mated state in which the connection object 50 and the connector 10 are mated with each other, the first extending portions 49b1 contact the second metal fitting 80 and are elastically deformed toward the outer peripheral wall 23 of the first insulator 20. The first metal fitting 40b and the second metal fitting 80 contact each other at two points on the front side and the back side due to the first extending portions 49b1 and the second locking portions 84 contacting each other.

When the first extending portions 49b1 are elastically deformed toward the outer peripheral wall 23 in the mated state, the contacted portions 267 of the first insulator 20 contact the surfaces of the first extending portions 49b1 facing the outer peripheral wall 23. More specifically, the inclined surfaces 267a of the contacted portions 267 contact lower edge portions of the surfaces of the first extending portions 49b1 facing the outer peripheral wall 23. Thus, corner portions, on the side near the outer peripheral wall 23, of the tips of the first extending portions 49b1 are separated from the inclined surfaces 267a of the contacted portions 267 in the unmated state and contact the inclined surfaces 267a of the contacted portions 267 in the mated state.

The second metal fitting 80 of the connection object 50 receives a urging force, acting toward the opposite side from the outer peripheral wall 23, from the first extending portions 49b1, which are elastically deformed toward the outer peripheral wall 23. The first extending portions 49b1, which contact the contacted portions 267 and are elastically deformed toward the outer peripheral wall 23, receive a resistance force from the inclined surfaces 267a of the contacted portions 267. The urging force and the resistance force provide the contact pressure of the first metal fitting 40b against the second metal fitting 80.

Parts P of the first extending portions 49b1 are illustrated by two-dot chain lines in FIG. 10. The parts P are at the same positions as the tips, in the protruding direction, of the protrusions of the second extending portions 49b2 in the mating direction in which the connection object 50 and the connector 10 mate with each other. The parts P are positioned further away from the outer peripheral wall 23 than the tips, in the protruding direction, of the protrusions in the unmated state in which the connection object 50 and the connector 10 are not mated with each other. The first extending portions 49b1 are positioned innermost in the front-back direction in the unmated state among the components of the first metal fitting 40b along the left-right direction.

On the other hand, the parts P of the first extending portions 49b1 are positioned nearer to the outer peripheral wall 23 side than the tips, in the protruding direction, of the protrusions of the second extending portions 49b2 are in the mated state in which the connection object 50 and the connector 10 are mated with each other. The tips, in the protruding direction, of the protrusions included in the engagement portions 49b3 are positioned nearer to the second metal fitting 80 than the parts P of the first extending portions 49b1 at the corresponding up-down positions are.

The top surface of the second base portion 43a of the second metal fitting 40a is flush with the top surface of the bottom plate portion 21. The top surface of the second base portion 43a is exposed upward from the second part 252 of the bottom plate portion 21. The top surface of the second base portion 43a faces the base portion 81 of the second metal fitting 80 with a slight separation in the up-down direction.

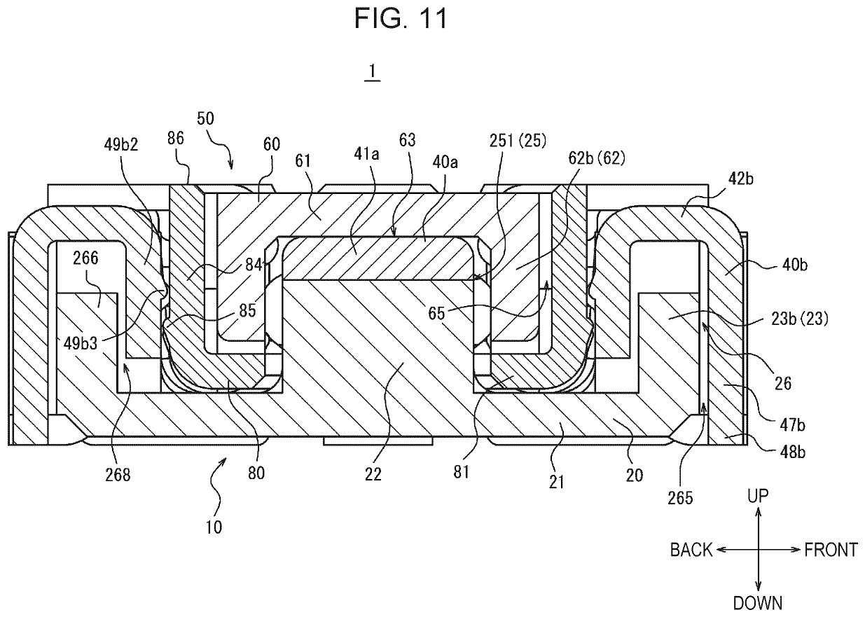

FIG. 11 is a sectional view taken along arrow line XI-XI in FIG. 1.

The engagement portions 49b3 of the second extending portions 49b2 engage with the protrusions 85 of the second metal fitting 80 in the mated state. More specifically, when the connection object 50 is moved downward relative to the connector 10 from the unmated state, the protrusions 85 of the connection object 50 contact the protrusions of the engagement portions 49b3 from the mating side. When the connection object 50 is moved further downward relative to the connector 10, the protrusions 85 move downward while contacting the protrusions of the engagement portions 49b3. At this time, the second extending portions 49b2 are slightly elastically deformed toward the outer peripheral wall 23 by the amount by which the protrusions of the engagement portions 49b3 and the protrusions 85 overlap in the front-back direction. The free ends of the second extending portions 49b2 are slightly displaced toward the outer peripheral wall 23 and received by the recesses 268 of the first insulator 20.

When the connection object 50 is moved further downward relative to the connector 10, the protrusions 85 pass over the protrusions of the engagement portions 49b3 and no longer contact each other. At this time, the second extending portions 49b2 return to the free state in which the second extending portions 49b2 are not elastically deformed toward the outer peripheral wall 23. The free ends of the second extending portions 49b2 return to being at the same positions as in the unmated state.

As described above, engagement of the engagement portions 49b3 and the protrusions 85 refers to a state in which one out of the engagement portions 49b3 and the protrusions 85 passes over the other out of the engagement portions 49b3 and the protrusions 85 and enters an engaged state. In the engaged state of the engagement portions 49b3 and the protrusions 85, the second extending portions 49b2 and the second metal fitting 80 may contact each other but do not need to contact each other. In FIG. 11, as an example, the second metal fitting 80, which includes the second locking portions 84 and the protrusions 85, and the second extending portions 49b2, which include the engagement portions 49b3, are slightly separated from each other and do not contact each other in the mated state.

In FIGS. 10 and 11, the thickness of the second metal fitting 40a is either substantially identical to the thickness of the first metal fitting 40b or smaller than the thickness of the first metal fitting 40b. Not limited to this configuration, the thickness of the second metal fitting 40a may be greater than the thickness of the first metal fitting 40b so that the strength of the second metal fitting 40a is greater than the strength of the first metal fitting 40b even if the second metal fitting 40a and the first metal fitting 40b are formed of the same material, for example.

In the embodiment described above, the connector 10 can realize both reliability of contact with the connection object 50 and workability despite being small in size and low in profile. For example, workability from mating of the connector 10 and the connection object 50 to each other to unmating of the connector 10 and the connection object 50 from each other is improved despite the reductions in size and profile.

In the connector 10, the elastically deformable first extending portions 49b1 and second extending portions 49b2, which include the engagement portions 49b3, are formed at different positions from each other on the base portions of the first metal fitting 40b. As a result, the amount of elastic deformation of the first extending portions 49b1 during mating is reduced compared to a connector of the related art in which protrusions are integrally formed on elastic contact pieces. Therefore, even when the first extending portions 49b1 become shorter and have a lower spring elasticity as the connector 10 becomes smaller and lower in profile, the deterioration of the first extending portions 49b1 occurring with repeated mating and unmating of the connector 10 and the connection object 50 is reduced.

Since the deterioration of the first extending portions 49b1 is reduced, the contact pressure applied from the first extending portions 49b1 to the connection object 50 is maintained for a longer period of time. This ensures that the conductive performance between the connector 10 and the connection object 50 in the mated state and the force with which the connection object 50 is held by the connector 10 are maintained for a longer period of time. In addition, the clicking sensation when the connector 10 and the connection object 50 are mated with each other and the extraction force when the connection object 50 is pulled out from the connector 10 in the mated state are also maintained for a longer period of time by the engagement portions 49b3 of the second extending portions 49b2, which are formed at different positions than the first extending portions 49b1. The connector 10 allows both the holding power realized by the first extending portions 49b1 and the clicking sensation and the extraction force realized by the engagement portions 49b3 of the second extending portions 49b2 to be maintained for a longer period of time even with the reductions in size and profile.

In the connector 10, the second extending portions 49b2 and the engagement portions 49b3 are easily adjusted in order to improve the clicking sensation and the extraction force described above because the first extending portions 49b1 and the second extending portions 49b2 are formed separately in the first metal fitting 40b. The second extending portions 49b2 and the engagement portions 49b3 can be adjusted while mainly considering only the clicking sensation and the extraction force without relying heavily on the contact pressure applied from the first metal fitting 40b to the connection object 50.

In the connector 10, the first extending portions 49b1 and the second extending portions 49b2 are formed separately in the first metal fitting 40b, and this facilitates adjustment of the first extending portions 49b1 in order to improve the contact pressure described above. The first extending portions 49b1 can be adjusted while considering mainly only the contact pressure applied from the first metal fitting 40b to the connection object 50 without heavily relying on the clicking sensation and extraction force.

Even if the second extending portions 49b2 including the engagement portions 49b3 deteriorate, the second extending portions 49b2 may be in contact with or not be in contact with the second metal fitting 80 of the connection object 50, and therefore the contact pressure applied from the first metal fitting 40b to the connection object 50 is not significantly affected. The reliability of contact between the connector 10 and the connection object 50 is maintained by the contact of the connection object 50 against the second metal fitting 80 at the first extending portions 49b1, independent of the state of the second extending portions 49b2. Therefore, both this contact reliability and workability based on the clicking sensation and extraction force can be achieved.

With the first extending portions 49b1 and the second extending portions 49b2 positioned on the long walls 23b, the first metal fitting 40b can pinch the connection object 50 in the lateral direction. Therefore, the first metal fitting 40b is able to support or hold the connection object 50 more stably than when the connection object 50 is pinched in the longitudinal direction. For example, the connector 10 can stably support the connection object 50 as a result of the first extending portions 49b1 and the second extending portions 49b2 of the first metal fitting 40b being contact in with the connection object 50 while pinching the connection object 50 in the lateral direction during the mating process. For example, the connector 10 can stably hold the connection object 50 as a result of the first extending portions 49b1 of the first metal fitting 40b contacting the connection object 50 in the mated state while pinching the connection object 50 in the lateral direction.

Because the first extending portions 49b1 and the second extending portions 49b2 are adjacent to each other, the first extending portions 49b1 can support the connection object 50 next to the engagement portions 49b3 of the second extending portions 49b2, which provide the clicking sensation during the mating process. The connector 10 can provide a stable clicking sensation via the second extending portions 49b2 while the first extending portions 49b1 support the connection object 50 adjacent to the second extending portions 49b2 during the mating process.

The first extending portions 49b1 are positioned nearer to the short wall 23a than the second extending portions 49b2 are on the long walls 23b. This allows the first extending portions 49b1 to contact the connection object 50 first, even if the connection object 50 is slightly tilted at an angle in a horizontal plane perpendicular to the up-down direction with respect to the connector 10 when mating the connection object 50 with the connector 10, for example. Thus, the first extending portions 49b1 can function like guides for leading the connection object 50 to the correct position inside the outer peripheral wall 23. The accuracy and workability of mating the connection object 50 with the connector 10 are improved.

In addition, when the connection object 50 is mated with the connector 10, the protrusions of the engagement portions 49b3 formed on the second extending portions 49b2 do not contact the connection object 50 first, and therefore damage to the protrusions of the engagement portions 49b3 is reduced. The first extending portions 49b1 also provide a protective effect for the protrusions of the engagement portions 49b3.

With the second extending portions 49b2 facing the mating protrusion 22, the left-right direction length of the long walls 23b, on which the first extending portions 49b1 and the second extending portions 49b2 are disposed, can be shortened. When two extending portions, including the first extending portion 49b1 and the second extending portion 49b2, are disposed on the long walls 23b, as in the connector 10, the long walls 23b tend to be longer along the longitudinal direction of the connector 10. Even in such a case, in the connector 10, the length in the longitudinal direction can be shortened by making at least one of the two extending portions overlap the mating protrusion 22 in the longitudinal direction.

Since the first insulator 20 includes the contacted portions 267, the first extending portions 49b1, which are elastically deformed toward the outer peripheral wall 23 in the mated state, make contact with the contacted portions 267. This increases the contact pressure of the first metal fitting 40b against the second metal fitting 80 resulting from the urging force exerted toward the opposite side from the outer peripheral wall 23, which is generated from the first extending portions 49b1 elastically deformed toward the outer peripheral wall 23, and the resistance force received by the first extending portions 49b1, which are in contact with the contacted portions 267, elastically deformed toward the outer peripheral wall 23. The connector 10 can hold the connection object 50 more firmly.

Since the contacted portions 267 have the inclined surfaces 267a, the contacted portions 267 can make contact with the first extending portions 49b1, which are elastically deformed toward the outer peripheral wall 23, at an earlier stage during the mating process than if the contacted portions 267 were formed as flat surfaces perpendicular to the bottom plate portion 21. This allows the connector 10 to exhibit the effects described above regarding holding of the connection object 50 more significantly.

Since the engagement portions 49b3 include the protrusions, the connector 10 can improve the clicking sensation when the connector 10 is mated with the connection object 50 through engagement of protrusions 85 of the second metal fitting 80 of the connection object 50 and the protrusions of the engagement portions 49b3. In addition, the connector 10 can also improve the extraction force when removing the connection object 50 from the connector 10 in the mated state.

In the connector 10, the parts P of the first extending portions 49b1, which are at the same positions in the mating direction as the tips, in the protruding direction, of the protrusions of the engagement portions 49b3, are positioned nearer to the opposite side from the outer peripheral wall 23 than the tips are in the unmated state, and are positioned nearer to the outer peripheral wall 23 than the tips are in the mated state. This allows the first extending portions 49b1 to contact the connection object 50 first, even if the connection object 50 is slightly tilted at an angle in a horizontal plane perpendicular to the up-down direction with respect to the connector 10 when mating the connection object 50 with the connector 10, for example. Thus, the first extending portions 49b1 can function like guides for leading the connection object 50 to the correct position inside the outer peripheral wall 23. The accuracy and workability of mating the connection object 50 with the connector 10 are improved.

In addition, when the connection object 50 is mated with the connector 10, the protrusions of the engagement portions 49b3 formed on the second extending portions 49b2 do not contact the connection object 50 first, and therefore damage to the protrusions of the engagement portions 49b3 is reduced. The first extending portions 49b1 also provide a protective effect for the protrusions of the engagement portions 49b3.

In the connector 10, the second metal fitting 40a attached to the mating protrusion 22 and the first metal fitting 40b attached to the outer peripheral wall 23 are different members from each other. This reduces the effect of contact between the metal fittings and the connection object 50 during the mating process, compared to techniques of the related art where the metal fittings are integrally formed. For example, even if a metal fitting and the connection object 50 contact each other on one of the mating protrusion 22 side and the outer peripheral wall 23 side, the effect of such contact on the other side is reduced. Thus, damage to metal fittings including the first metal fitting 40b and the second metal fitting 40a is reduced. Since damage to the metal fittings is reduced, damage to the first insulator 20 to which the metal fittings are attached is also reduced. As a result, the reliability of the connector 10 as a product is improved.

Even if the mating is performed with the connection object 50 misaligned with the connector 10 and the connection object 50 contacts the first metal fitting 40b on the outer peripheral wall 23 side during the mating process and causes the first metal fitting 40b and the outer peripheral wall 23 to deform and collapse outward in the left-right direction, the effect on the mating protrusion 22 side is reduced. The fact that the first metal fitting 40b and the second metal fitting 40a are different members from each other reduces deformation of the second metal fitting 40a. Even if the connection object 50 contacts the second metal fitting 40a on the mating protrusion 22 side during the mating process, causing the second metal fitting 40a and the mating protrusion 22 to deform inward in the left-right direction, the effect on the outer peripheral wall 23 side is reduced. The fact that the first metal fitting 40b and the second metal fitting 40a are different members from each other reduces deformation of the first metal fitting 40b. Thus, each of the metal fittings exhibits independent and separate behavior on one of the mating protrusion 22 side and the outer peripheral wall 23 side. Therefore, transmission of the behavior to the other side is reduced. As a result, the desired function can be consistently performed throughout the fittings, and therefore damage is reduced.

By reducing damage to the metal fittings and the first insulator 20 as described above, misalignment between the connector 10 and the connection object 50 in the arrangement direction of the contacts during and after mating, i.e., in the longitudinal direction of the connector 10, is reduced. This ensures that conductivity between the first contacts 30 and second contacts 70 is achieved exactly according to the original design. In addition, rattling of the connector module 1 after mating is reduced. The function of regulating the position of one of the connector 10 and the connection object 50 relative to the other is maintained. As a result, one is less likely to come loose from the other, and the reliability of the connector module 1 as a product is improved.

In the connector 10, the first metal fitting 40b and the second metal fitting 40a are different members from each other, and this allows the strength of one of the first metal fitting 40b and the second metal fitting 40a to be made higher than that of the other. In the connector 10, the first metal fitting 40b and the second metal fitting 40a, which are attached for different purposes at different locations from each other, such as for example, the mating protrusion 22 and the outer peripheral wall 23, can be formed with the appropriate strength for each metal fitting to suit the location and purpose. For example, when metal fittings are formed in an integrated manner, as in techniques of the related art, if the strength of a metal fitting has to be reduced on one of the mating protrusion 22 side and the outer peripheral wall 23 side, the strength of the metal fitting on the other side will inevitably be reduced.

For example, the main purpose of the second metal fitting 40a attached to the mating protrusion 22 is to improve the robustness of the mating protrusion 22. On the other hand, the main purpose of the first metal fitting 40b attached to the outer peripheral wall 23 is to obtain conductivity by contacting the second metal fitting 80 in the mated state. For this purpose, the elastically deformable first extending portions 49b1 are formed in the first metal fitting 40b.

Therefore, the first metal fitting 40b is preferably formed of a material with a strength that allows springiness, whereas the second metal fitting 40a is preferably formed of a stronger material. In the connector 10, the first metal fitting 40b and the second metal fitting 40a can be formed with the appropriate strengths that are suitable for their respective purposes. For example, if metal fittings are formed in an integrated manner as in techniques of the related art, the strength of the metal fitting as a whole will inevitably be reduced by the formation of elastically deformable contact pieces on the outer peripheral wall side, and the robustness of the mating protrusion will also be reduced.

Because the material of the second metal fitting 40a is different from the material of the first metal fitting 40b, each metal fitting can be easily formed so that the strength of one of the first metal fitting 40b and the second metal fitting 40a is higher than the strength of the other. For example, the materials of the first metal fitting 40b and the second metal fitting 40a described above can be appropriately selected to suit their purposes.

Since the strength of the material of the second metal fitting 40a is higher than the strength of the material of the first metal fitting 40b, the robustness of the mating protrusion 22 to which the second metal fitting 40a is attached is improved. Therefore, damage to the mating protrusion 22 of the first insulator 20 to which the second metal fitting 40a is attached is reduced. As a result, the reliability of the connector 10 as a product is improved.

By making the thickness of the second metal fitting 40a greater than that of the first metal fitting 40b, the strength of the second metal fitting 40a is higher than that of the first metal fitting 40b, even if the first metal fitting 40b and the second metal fitting 40a are formed of the same material. Thus, the robustness of the mating protrusion 22 to which the second metal fitting 40a is attached is improved in the same way as described above.

The robustness of the mating protrusion 22 is improved at both ends of the mating protrusion 22 by attachment of the pair of second metal fittings 40a to both ends of the mating protrusion 22 in the longitudinal direction of the connector 10. Therefore, damage to the mating protrusion 22 of the first insulator 20 to which the pair of second metal fittings 40a is attached is further reduced. As a result, the reliability of the connector 10 as a product is further improved.

In the connector 10, the second metal fitting 40a includes the mounting portion 44a that is mounted on the circuit board CB1, and this improves the robustness of the second metal fitting 40a. Even if a load is applied to the second metal fitting 40a, deformation of the second metal fitting 40a is reduced and the shape and dimensional accuracy of the connector 10 is maintained during the mating process. For example, the robustness of the mating protrusion 22 to which the second metal fitting 40a is attached is improved. Therefore, damage to the mating protrusion 22 such as deformation is reduced, and the effects described above regarding rattling and misalignment in the longitudinal direction of the connector 10 are achieved.

The mounting portion 44a includes a bottom surface on the circuit board CB1 side, and therefore an external force acting on the second metal fitting 40a can be received by the mounting portion 44a. When the mounting portion 44a is mounted on the circuit board CB1, the second metal fitting 40a is fixed to the circuit board CB1, and even if an external force is applied to the second metal fitting 40a, the shock is absorbed by the mounting portion 44a. Therefore, the robustness of the second metal fitting 40a along the longitudinal direction of the connector 10 is improved. Thus, the robustness of the mating protrusion 22 along the longitudinal direction of the connector 10 is also improved.

The second metal fitting 40a overlaps, along the arrangement direction, with one first contact 30 positioned at the end in the arrangement direction among the multiple first contacts 30, and as a result, the length of the connector 10 in the longitudinal direction is shortened. Thus, the length of the connector module 1 in the longitudinal direction is shortened and the connector module 1 is reduced in size. In addition, the connector module 1 is more resistant to external forces.

The tip 42a1 of the claw portion 42a of the second metal fitting 40a is positioned between one first contact 30 and another first contact 30. Thus, any tip structure of the claw portion 42a is disposed in a thick part of the first insulator 20 where no first contact mounting grooves 24 are formed. Therefore, the holding strength of the tip 42a1 of the claw portion 42a to the first insulator 20 is improved. This improves the holding strength of the second metal fitting 40a to the first insulator 20. On the other hand, by disposing any tip structure of the claw portion 42a in a thick part of the first insulator 20, a reduction in the rigidity of the mating protrusion 22 of the first insulator 20 is reduced compared to when the tip structure of the claw portion 42a is disposed so to overlap a part where the first contact mounting grooves 24 are formed.

Curling up of the claw portion 42a is reduced due to the claw portion 42a being formed in an L-shape and the tip 42a1 of the claw portion 42a being buried inside the mating protrusion 22. Therefore, the holding strength of the claw portion 42a to the first insulator 20 is improved. This improves the holding strength of the second metal fitting 40a to the first insulator 20.

The first base portion 41a and the second base portion 43a are integrally formed to be crank-shaped on the whole, and as a result, the entirety of the second metal fitting 40a is integrated with the first insulator 20 along the edge of the mating protrusion 22 and the shape of the bottom plate portion 21. Therefore, the holding strength of the second metal fitting 40a to the first insulator 20 is improved.

In the lateral direction of the connector 10, the claw portion 42a is narrower than the other parts of the second metal fitting 40a, and consequently, the thickness of the first insulator 20 is increased at the place where the first insulator 20 is integrated with the claw portion 42a. For example, even if the claw portion 42a overlaps, along the arrangement direction, with one first contact 30 positioned at the end in the arrangement direction and the first contact mounting groove 24 is formed at the corresponding location, the strength of the first insulator 20 is maintained due to the claw portion 42a being formed with a narrow width. As a result, the robustness of the connector 10 is improved.

The second base portion 43a of the second metal fitting 40a extends along the longitudinal direction of the connector 10 from the mating protrusion 22 to the short wall 23a where the first metal fitting 40b is attached, and as a result, the robustness of the second metal fitting 40a along the longitudinal direction of the connector 10 is improved. Thus, the robustness of the mating protrusion 22 along the longitudinal direction of the connector 10 is also improved. In addition, the same effects as described above are obtained between the short wall 23a and the mating protrusion 22, which are separated from each other in the longitudinal direction of the connector 10. Even if a metal fitting and the connection object 50 contact each other on one of the mating protrusion 22 side and the short wall 23a side, the effect of such contact on the other side is reduced.

The first mounting portions 44b of the first metal fitting 40b are disposed on both sides of the second metal fitting 40a in the lateral direction of the connector 10. The second mounting portions 48b of the first metal fitting 40b are disposed on both sides of the second metal fitting 40a in the lateral direction of the connector 10. Thus, the mounting strength of the first metal fitting 40b on the circuit board CB1 is improved. Therefore, the robustness along the left-right direction of the first metal fitting 40b and the short wall 23a is improved.

The pair of first mounting portions 44b are disposed at substantially the same left-right position as the mounting portion 44a, and therefore, three mounting portions are located on a straight line along the front-back direction. Thus, the mounting strength of the connector 10 on the circuit board CB1 is improved. For example, even if the mating is performed with the connection object 50 misaligned with the connector 10 at a prescribed angle with respect to the connector 10 using the up-down direction as an axis, mounting of the connector 10 on the circuit board CB1 is maintained. Similarly, even if the circuit board CB1 on which the connector 10 is mounted rotates after mating, the mounting of the connector 10 on the circuit board CB 1 is maintained. Therefore, the robustness of the connector 10 mounted on the circuit board CB1 is improved.

Due to part of the first metal fitting 40b being disposed on both sides of the second base portion 43a of the second metal fitting 40a in the lateral direction of the connector 10, the area of attachment of the first metal fitting 40b to the first insulator 20 is increased. Thus, the attachment strength of the first metal fitting 40b to the first insulator 20 is improved.

The pair of first metal fittings 40b are respectively attached to the pair of short walls 23a, and this improves the robustness of the short walls 23a at both ends of the outer peripheral wall 23 in the left-right direction. Therefore, damage to the short walls 23a of the first insulator 20, to which the pair of first metal fittings 40b are attached, is further reduced. As a result, the reliability of the connector 10 as a product is further improved.

Since the first metal fitting 40b includes the elastically deformable first extending portions 49b1 that contact the second metal fitting 80 in the mated state, the connection state with the second metal fitting 80 can be stably maintained by the elastic force at the first extending portions 49b1. Therefore, electrical conduction between the first metal fitting 40b and the second metal fitting 80 is stably maintained in the mated state.

In the mated state in which the connector 10 and the connection object 50 are mated with each other with the first metal fitting 40b and second metal fitting 40a separated from each other and facing each other in the left-right direction, the second metal fitting 80 of the connection object 50 can be positioned between the first metal fitting 40b and the second metal fitting 40a. Thus, the first metal fitting 40b is positioned to sandwich the second metal fitting 80 together with the second metal fitting 40a in the mated state, and this reduces rattling of the connector module 1 after mating. The shape and dimensional accuracy of the connector 10 is maintained during the mating process, and the function of regulating the position of one of the connector 10 and the connection object 50 with respect to the other is maintained after mating. As a result, one is less likely to come loose from the other, and the reliability of the connector module 1 as a product is improved.

The robustness of the second metal fitting 40a and the mating protrusion 22 is further improved by the second metal fitting 40a and the first insulator 20 being integrally molded with each other through insert molding. The contact area between the second metal fitting 40a and the first insulator 20 is increased due to the second base portion 43a of the second metal fitting 40a being integrally molded with the first insulator 20 at the bottom plate portion 21 in the second part 252 of the second metal fitting holding portion 25. Thus, the holding strength of the second metal fitting 40a to the first insulator 20 is improved by insert molding. Therefore, the robustness of the second metal fitting 40a and the mating protrusion 22 is further improved.

The fact that the present disclosure can be realized in certain forms other than the embodiment described above without departing from the spirit or essential features thereof is obvious to those skilled in the art. Therefore, the foregoing description is illustrative and the present disclosure is not limited thereto. The scope of the disclosure is defined by the appended claims rather than by the foregoing description. Any changes that lie within the scope of equivalents are intended to be included within the scope of the disclosure.

For example, the shape, arrangement, orientation, and number of each of the above-mentioned components are not limited to those given in the above description and drawings. The shape, arrangement, orientation, and number of each component may be freely set as long as the functions of the component can be achieved.

For example, in the connector 10, at least one of the first metal fitting 40b or the first contacts 30 may be integrally molded with the first insulator 20 by insert molding instead of press-fitting. For example, in the connector 10, the second metal fitting 40a may be attached to the first insulator 20 by press-fitting instead of insert molding.

In the above embodiment, the first extending portions 49b1 are described as being formed as a pair in the first metal fitting 40b, but the first extending portions 49b1 are not limited to this configuration. The first extending portions 49b1 may be formed at any positions in the first metal fitting 40b in two or more pairs, or may be formed at any position in any number of one or more without being formed as pairs. The second extending portions 49b2 are described as being formed as a pair in the first metal fitting 40b, but the second extending portions 49b2 are not limited to this configuration. The second extending portions 49b2 may be formed at any positions in two or more pairs in the first metal fitting 40b.

In the above embodiment, the first extending portions 49b1 and the second extending portions 49b2 are described as being positioned on the long walls 23b, but the extending portions are not limited to this configuration. At least one of the first extending portions 49b1 or the second extending portions 49b2 may be positioned on the short walls 23a instead of or in addition to the long walls 23b.

In the above embodiment, the first extending portions 49b1 and the second extending portions 49b2 are described as being adjacent to each other, but the extending portions are not limited to this configuration. The first extending portions 49b1 and the second extending portions 49b2 do not need to be adjacent to each other.

In the above embodiment, the first extending portions 49b1 are described as being positioned nearer to the short wall 23a than the second extending portions 49b2 are on the long walls 23b, but the first extending portions 49b1 are not limited to this configuration. The first extending portions 49b1 may be positioned nearer to the opposite side from the short wall 23a than the second extending portions 49b2 are on the long walls 23b.

In the above embodiment, the second extending portions 49b2 are described as facing the mating protrusion 22, but the second extending portions 49b2 are not limited to this configuration. The second extending portions 49b2 do not need to face the mating protrusion 22. For example, the first extending portions 49b1 may face the mating protrusion 22 instead of the second extending portions 49b2. For example, in addition to the second extending portions 49b2, the first extending portions 49b1 also do not need to face the mating protrusion 22.

In the above embodiment, the first extending portions 49b1 and the second extending portions 49b2 are described as being formed with substantially the same width as each other along the long walls 23b, but the extending portions are not limited to this configuration. The first extending portions 49b1 may be wider than the second extending portions 49b2 along the long walls 23b. In this way, the contact pressure applied from the first extending portions 49b1 to the second metal fitting 80 of the connection object 50 is increased.

In the above embodiment, the first insulator 20 is described as including the contacted portions 267, but the first insulator 20 is not limited to this configuration. The first insulator 20 does not need to include a configuration such as the contacted portions 267. The first extending portions 49b1 of the first metal fitting 40b do not need to contact the first insulator 20 in the mated state.

In the above embodiment, each contacted portion 267 is described as having the inclined surface 267a that slopes inward from the long wall 23b as one moves toward the opposite side from the mating side between the connection object 50 and the connector 10 on the long wall 23b, but the contacted portions 267 are not limited to this configuration. The contacted portion 267 may have any other configuration of being formed on the inner side of the outer peripheral wall 23 and on the opposite side from the mating side with respect to the mating side where mating takes place between the connection object 50 and the connector 10. For example, the contacted portion 267 may be configured to change in a staircase-like manner as one moves toward the opposite side from the mating side between the connection object 50 and the connector 10, instead of being configured to be continuously inclined inward from the outer peripheral wall 23 like the inclined surface 267a.

The contacted portion 267 does not need to be formed on the inner side of the outer peripheral wall 23 and on the opposite side from the mating side with respect to the mating side where mating takes place between the connection object 50 and the connector 10. For example, the contacted portion 267 may have a flat surface that is perpendicular to the bottom plate portion 21 instead of the inclined surface 267a. The contacted portion 267 may be formed so as to rise in a mountain shape with a curved surface having any degree of curvature instead of the perpendicular flat surface and the inclined surface 267a. The contacted portions 267 may be formed on the short walls 23a instead of or in addition to the long walls 23b.

In the above embodiment, the corner, on the outer peripheral wall 23 side, of each first extending portion 49b1 contacting the corresponding contacted portion 267 is described as being formed as a right angle, but the corner is not limited to this configuration. The corner may have a rounded shape. Therefore, damage to the first insulator 20 caused by contact between the first metal fitting 40b and the first insulator 20 at the contacted portions 267 is reduced. Therefore, contact pressure applied from the first extending portions 49b1 to the connection object 50 is maintained for a longer period of time. The robustness of the connector 10 is improved and the reliability of the connector 10 as a product is improved.

In the above embodiment, the engagement portions 49b3 are described as including protrusions projecting toward the opposite side from the outer peripheral wall 23 on the surfaces of the second extending portions 49b2, but the engagement portions 49b3 are not limited to this configuration. The engagement portions 49b3 may include any structure that can engage with the second metal fitting 80 and provide a clicking sensation when mating. For example, the engagement portions 49b3 may include recesses or through holes that engage with the protrusions 85 of the second metal fitting 80.

In the above embodiment, the parts P of the first extending portions 49b1 are described as being positioned nearer to the opposite side from the outer peripheral wall 23 than the tips, in the projecting direction, of the engagement portions 49b3 are in the unmated state and as being positioned nearer to the outer peripheral wall 23 than the tips are in the mated state, but the parts P are not limited to this configuration. For example, the parts P of the first extending portions 49b1 may be positioned nearer to the outer peripheral wall 23 than the tips, in the projecting direction, of the protrusions of the engagement portions 49b3 are in the unmated state.

In the above embodiment, the first metal fitting 40b and the second metal fitting 40a are described as being separated from each other, but are not limited to this configuration. The first metal fitting 40b and the second metal fitting 40a may be connected to each other and not separated from each other. At this time, the first metal fitting 40b and the second metal fitting 40a may be formed to have different strengths from each other in the whole integrated metal fitting. For example, the integrated metal fitting, including the first metal fitting 40b and the second metal fitting 40a, may be made of a functional gradient material. More specifically, the material of the second metal fitting 40a may be a different material from the material of the first metal fitting 40b such that the strength of the material of the second metal fitting 40a is higher than the strength of the material of the first metal fitting 40b. For example, the integrated metal fitting including the first metal fitting 40b and the second metal fitting 40a may be formed with different thicknesses. More specifically, the thickness of the second metal fitting 40a may be larger than the thickness of the first metal fitting 40b.

In the above embodiment, the strength of the second metal fitting 40a is described as being higher than the strength of the first metal fitting 40b, but is not limited to this. The strength of the first metal fitting 40b may be higher than the strength of the second metal fitting 40a.

The above embodiment describes that the thickness of the second metal fitting 40a may be greater than the thickness of the first metal fitting 40b so that the strength of the second metal fitting 40a is higher than the strength of the first metal fitting 40b, but the above embodiment not limited to this configuration. For example, even if the thickness of the second metal fitting 40a is smaller than the thickness of the first metal fitting 40b, the strength of the second metal fitting 40a may be higher than the strength of the first metal fitting 40b. Conversely, even if the thickness of the second metal fitting 40a is greater than the thickness of the first metal fitting 40b, the strength of the second metal fitting 40a may be lower than the strength of the first metal fitting 40b.

In the above embodiment, the second metal fitting 40a is described as overlapping one first contact 30 in the arrangement direction, but is not limited to this configuration. So long as a reduction in the size of the connector 10 in the longitudinal direction can be realized, the second metal fitting 40a does not need to overlap one first contact 30 in the arrangement direction.

In the above embodiment, the tip 42a1 of the claw portion 42a of the second metal fitting 40a is described as being positioned between one first contact 30 and another first contact 30 in the arrangement direction, but is not limited to this configuration. The tip 42a1 of the claw portion 42a of the second metal fitting 40a may be positioned at a left-right position that is the same as the attachment position of a first contact 30, for example, as long as the holding strength of the tip 42a1 of the claw portion 42a of the second metal fitting 40a to the first insulator 20 can be maintained.

In the above embodiment, the claw portion 42a is described as being formed in an L-shape and the tip 42a1 of the claw portion 42a is described as being buried inside the mating protrusion 22, but the claw portion 42a is not limited to this configuration. So long as the holding strength of the claw portion 42a to the first insulator 20 can be maintained, the claw portion 42a may be formed in any shape other than an L-shape. Similarly, the tip 42a1 of the claw portion 42a does not need to be buried inside the mating protrusion 22.

In the above embodiment, the claw portion 42a is described as being narrower than the other parts of the second metal fitting 40a in the lateral direction of the connector 10, but the claw portion 42a is not limited to this configuration. So long as the strength of the first insulator 20 is maintained, the claw portion 42a may have the same width as the other parts of the second metal fitting 40a.

In the above embodiment, the second base portion 43a is described as extending from the mating protrusion 22 to the short wall 23a to which the first metal fitting 40b is attached, but the second base portion 43a is not limited to this configuration. So long as the robustness of the second metal fitting 40a along the longitudinal direction of the connector 10 is improved, the second base portion 43a may extend from the mating protrusion 22 toward the short wall 23a with any length.

In the above embodiment, the mounting portion 44a is described as being positioned directly below the short wall 23a, but is not limited to this configuration. The mounting portion 44a may be located at a position adjacent to the mating protrusion 22 so as to be near to a position in the second metal fitting 40a where an external force is likely to act.

In the above embodiment, the first metal fittings 40b are described as being attached to the short walls 23a, but are not limited to this configuration. For example, the first metal fittings 40b may be attached to only the long walls 23b and not attached to the short walls 23a.

In the above embodiment, the first mounting portions 44b of the first metal fitting 40b are described as being disposed on both sides of the second metal fitting 40a in the lateral direction of the connector 10 and the second mounting portions 48b are described as being disposed on both sides of the second metal fitting 40a in the lateral direction of the connector 10, but the mounting portions are not limited to this configuration. Either the first mounting portions 44b or the second mounting portions 48b may be disposed on both sides of the second metal fitting 40a in the lateral direction of the connector 10. Rather than two, only one or three or more of the first mounting portions 44b may be formed. Similarly, rather than two, only one or three or more of the second mounting portions 48b may be formed.

The connector module 1, the connector 10, or the connection object 50 as described above is mounted in an electronic device containing the circuit board CB1 and the circuit board CB2. Examples of the electronic device include any communication terminal device, such as a smartphone, and any information processing device, such as a personal computer, a copier, a printer, a facsimile machine, and a multifunction machine. Examples of the electronic device include any in-vehicle device such as a camera, a radar, a drive recorder, and an engine control unit. Examples of the electronic device include any other in-vehicle devices used in in-vehicle systems such as car navigation systems, advanced driver assistance systems, or security systems. Other examples of the electronic device include any industrial equipment.

In such an electronic device, the connector 10 can realize both reliability of contact with the connection object 50 and workability despite being small in size and low in profile. Therefore, workability in the process of the manufacturing the electronic device is improved.

The following concepts can be extracted from the present disclosure.
(1)

A connector configured to mate with a connection object, the connector comprising:
an insulator including an outer peripheral wall positioned on an outer periphery of the connector; and
a first metal fitting attached to the outer peripheral wall,
wherein the first metal fitting includes base portions disposed along the outer peripheral wall,
first extending portions extending from the base portions inward from the outer peripheral wall, and
a pair of second extending portions facing each other and extending inward from the outer peripheral wall from different positions on the base portions than the first extending portions,
in a mated state in which the connection object and the connector are mated with each other, the first extending portions contact a second metal fitting of the connection object and elastically deform toward the outer peripheral wall, and
the second extending portions include engagement portions that engage with the second metal fitting in the mated state.
(2) The connector according to (1),
   wherein the outer peripheral wall includes long walls and a short wall, and
   the first extending portions and the second extending portions are positioned on the long walls.
(3)

The connector according to (2),
wherein the first extending portions and the second extending portions are adjacent to each other.
(4)

The connector according to (2) or (3),
wherein the first extending portions are positioned nearer to the short wall than the second extending portions are on the long walls.
(5)

The connector according to any one of (2) to (4),
wherein the insulator includes a mating protrusion surrounded by the outer peripheral wall, and
the second extending portions face the mating protrusion.
(6)

The connector according to any one of (2) to (5),
wherein the first extending portions are wider than the second extending portions along the long walls.
(7)

The connector according to any one of (1) to (6), wherein the insulator includes contacted portions that are contacted in the mated state by surfaces of the first extending portions facing the outer peripheral wall.
(8)

The connector according to (7),
wherein with respect to a mating side where mating takes place between the connection object and the connector, the contacted portions are positioned on an opposite side from the mating side and on an inner side of the outer peripheral wall.
(9)

The connector according to (8),
wherein the contacted portions have inclined surfaces that are inclined inward from the outer peripheral wall with increasing proximity to the opposite side from the mating side on the outer peripheral wall.
(10)

The connector according to any one of (7) to (9),
wherein corners of the first extending portions that contact the contacted portions have a rounded shape.
(11)

The connector according to any one of (1) to (10),
wherein the engagement portions include protrusions that project toward an opposite side from the outer peripheral wall on surfaces of the second extending portions.
(12)

The connector according to (11),
wherein parts of the first extending portions located at identical positions as tips, in a projecting direction, of the protrusions, in a mating direction between the connection object and the connector, are positioned nearer to the opposite side from the outer peripheral wall than the tips are in the unmated state and are positioned nearer to the outer peripheral wall than the tips are in the mated state.
(13)

An electronic device comprising:
the connector according to any one of (1) to (12).

### REFERENCE SIGNS

1 connector module
10 connector
20 first insulator (insulator)
21 bottom plate portion
22 mating protrusion
23 outer peripheral wall
23a short wall
23b long wall
24 first contact mounting groove
25 second metal fitting holding portion
251 first part
252 second part
253 third part
26 first metal fitting mounting portion
261 first wall portion
262 second wall portion
263 third wall portion
264 first attachment groove
265 second attachment groove
266 fourth wall portion
267 contacted portion
267a inclined surface
268 recess
30 first contact
31 mounting portion
32 locking portion
33 curved portion
34 elastic contact piece
35 elastic contact portion
36 contact portion
40a second metal fitting
41a first base portion
42a claw portion
42a1 tip
43a second base portion
44a mounting portion
40b first metal fitting (first metal fitting)
41b first base portion (base portion)
42b second base portion (base portion)
43b projecting piece
44b first mounting portion
45b first locking portion
46b bent portion
47b second locking portion
48b second mounting portion
49b1 first extending portion
49b2 second extending portion
49b3 engagement portion
50 connection object
60 second insulator
61 bottom plate portion
62 outer peripheral wall
62a short wall
62b long wall
63 mating recess
64 second contact holding portion
65 metal fitting holding portion
70 second contact
71 mounting portion
72 curved portion
73 contact portion
80 second metal fitting (second metal fitting)
81 base portion
82 first mounting portion
83 first locking portion
84 second locking portion
85 protrusion
86 second mounting portion
CB1 circuit board
CB2 circuit board
P part

1. A connector configured to mate with a connection object, the connector comprising:
an insulator including an outer peripheral wall positioned on an outer periphery of the connector; and
a first metal fitting attached to the outer peripheral wall,
wherein the first metal fitting includes base portions disposed along the outer peripheral wall,
first extending portions extending from the base portions inward from the outer peripheral wall, and
a pair of second extending portions facing each other and extending inward from the outer peripheral wall from different positions on the base portions than the first extending portions,
in a mated state in which the connection object and the connector are mated with each other, the first extending portions contact a second metal fitting of the connection object and elastically deform toward the outer peripheral wall, and
the second extending portions include engagement portions that engage with the second metal fitting in the mated state.

2. The connector according to claim 1,
wherein the outer peripheral wall includes long walls and a short wall, and
the first extending portions and the second extending portions are positioned on the long walls.

3. The connector according to claim 2,
wherein the first extending portions and the second extending portions are adjacent to each other.

4. The connector according to claim 2,
wherein the first extending portions are positioned nearer to the short wall than the second extending portions are on the long walls.

5. The connector according to claim 2, wherein the insulator includes a mating protrusion surrounded by the outer peripheral wall, and
the second extending portions face the mating protrusion.

6. The connector according to claim 2,
wherein the first extending portions are wider than the second extending portions along the long walls.

7. The connector according to claim 1,
wherein the insulator includes contacted portions that are contacted in the mated state by surfaces of the first extending portions facing the outer peripheral wall.

8. The connector according to claim 7,
wherein with respect to a mating side where mating takes place between the connection object and the connector, the contacted portions are positioned on an opposite side from the mating side and on an inner side of the outer peripheral wall.

9. The connector according to claim 8,
wherein the contacted portions have inclined surfaces that are inclined inward from the outer peripheral wall with increasing proximity to the opposite side from the mating side on the outer peripheral wall.

10. The connector according to claim 7,
wherein corners of the first extending portions that contact the contacted portions have a rounded shape.

11. The connector according to claim 1,
wherein the engagement portions include protrusions that project toward an opposite side from the outer peripheral wall on surfaces of the second extending portions.

12. The connector according to claim 11,
wherein parts of the first extending portions located at identical positions as tips, in a projecting direction, of the protrusions, in a mating direction between the connection object and the connector, are positioned nearer to the opposite side from the outer peripheral wall than the tips are in the unmated state and are positioned nearer to the outer peripheral wall than the tips are in the mated state.

13. An electronic device comprising:
the connector according to claim 1.
